(19) United States
(12) Patent Application Publication
(10) Pub. No.: US 2011/0267384 A1
(43) Pub. Date: Nov. 3, 2011

(54) ILLUMINATION DEVICE, DISPLAY DEVICE, DATA GENERATION METHOD, DATA GENERATION PROGRAM, AND RECORDING MEDIUM

(75) Inventors: Kohji Fujiwara, Osaka-shi (JP); Takayuki Murai, Osaka (JP)

(73) Assignee: Sharp Kabushiki Kaisha, Osaka-shi, Osaka (JP)

(21) Appl. No.: 13/138,103

(22) PCT Filed: Nov. 5, 2009
(86) PCT No.: PCT/JP2009/068868

§ 371 Date: Jul. 7, 2011

(30) Foreign Application Priority Data
Feb. 25, 2009 (JP) 2009041716

(51) Int. Cl. G09G 3/36; G09G 5/10

(52) U.S. Cl. 345/690; 345/102

(57) ABSTRACT

Under control of a main microcomputer, an LED controller generates two frame-type LED control signals corresponding to two frame image signals arranged in time series in accordance with a panel processing color video signal. Furthermore, the LED controller generates from two frame-type LED control signals, a frame-type LED signal corresponding to an interpolation frame image signal temporally between the two frame image signals.

### TECHNICAL FIELD

The present invention relates to an illumination device like a backlight unit, for example, and to a display device (liquid crystal display device and the like) that includes the illumination device. Besides, the present invention relates to: a data generation method for generating light amount adjustment data for controlling a light source of the illumination device; a data generation program for generating the light amount adjustment data; and further a record medium for recording the data generation program.

### BACKGROUND ART

Recently, in display devices such as a liquid crystal display device and the like, a liquid crystal display panel controller that controls a liquid crystal panel has a generation function for generating an interpolation frame image signal (patent document 1). The generation function for generating an interpolation frame, from a frame image signal that is based on a signal (panel control data) which is part of an image signal (image data) and is transmitted to the liquid crystal display panel controller, generates an interpolation fame image signal for interpolating each frame image signal; and inserts the generated frame image signal between the frame image signal data.

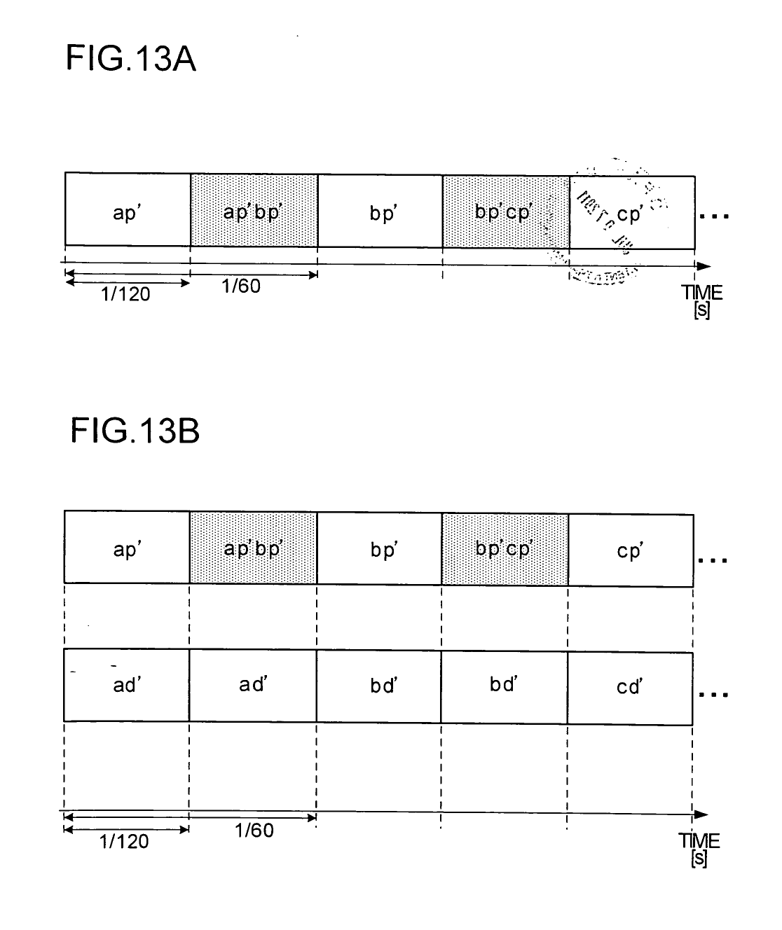

This function is simply shown in FIG. 13A. In detail, FIG. 13A is a diagram in which frame image signals (frame image data) ap′, bp′, cp′, . . . and interpolation frame image signals (interpolation fame image data) ap′bp′, bp′cp′ . . . generated from these frame image signals are arranged in time series (here, for example, it is meant that the interpolation frame image signals ap′bp′ is generated from the frame image signal ap′ and the frame image signal bp′).

In a case where such interpolation frame image signal is interpolated between the frame image signals, usually, a display image on a liquid crystal display panel becomes a high-quality image compared with a display image that displays the frame image signal only.

### Citation List

### Patent Literature

PLT1: JP-A-2008-11197

SUMMARY OF INVENTION

### Technical Problem

In the meantime, the image signal, besides the signal transmitted to the liquid crystal display panel controller, includes a signal (light source control data) for controlling a light source (e.g., an LED (Light Emitting Diode) that is incorporated in a backlight unit. And, in accordance with a signal (light amount adjustment data) after various processes applied to this signal, light emission from the LED is controlled (here, a member that performs such various processes is called a microcomputer unit, that is, a micro unit).

In detail, the micro unit (control unit), based on a signal (light source control data) for controlling the LED, generates a frame-type LED control signal (frame- corresponding-type light amount adjustment data) as a signal that corresponds to a frame (one screen). Especially, the micro unit makes the frame-type LED control signal correspond to a frame image signal. For example, as shown in FIG. 13B, as the frame-type LED control signals that correspond to the frame image signals ap′, bp′, cp′ . . . , frame-type LED control signals ad′, bd′, cd′ . . . are generated.

Here, as shown in FIG. 13A and FIG. 13B, the frame image signals ap′, bp′, cp′ . . . and the interpolation frame image signals ap′bp′, bp′cp′ . . . are signals that are obtained by double-speeding a frame frequency of 60 Hz. Accordingly, in order to synchronize the frame-type LED control signals with the frame image signals ap′, bp′, cp′, . . . and the interpolation frame image signals ap′bp′, bp′cp′, . . . the micro unit also double-speeds the frame-type LED control signals. Usually, as shown in FIG. 13B, the micro unit simply double-speeds the frame-type LED control signals ad′, bd′, cd′ . . . .

In this case, for example, between the frame image signal ap′ and the frame- type LED control signal ad′ that synchronize with each other, a corresponding relationship is satisfied; however, the interpolation frame image signal ap′bp′ does not corresponds to the frame-type LED control signal ad′. Because of this, the display image on the liquid crystal display panel based on the interpolation frame image signal receives light (backlight) that is based on the frame-type LED control signal that does not have a corresponding relationship. Because of this, on this display image, image blur, dynamic-image trouble (flicker) and the like easily occur.

The present invention has been made to solve the above problems. And, for example, it is an object of the present invention to provide an illumination device and the like that achieve a high quality of a display image on a liquid crystal display panel.

### Solution to Problem

The illumination device includes: a plurality of light sources that emit light in accordance with light amount adjustment data; and
a control unit that from image data which is a base of panel control data and light source control data, generates the light amount adjustment data by applying a process to the light source control data.

And, in this illumination device, the control unit, based on the panel control data, generates the light amount adjustment data of a frame type to the number of 2 while making the light amount adjustment data correspond to two frame image data that are arranged in time series; and
from the two light amount adjustment data of the frame type, generates the light amount adjustment data of an interpolation frame type that corresponds to intermediate interpolation frame image data in a time passage between the two frame image data.

According to this, the light amount adjustment data of the interpolation frame type, which is in good harmonization with the interpolation frame image data based on the two frame image data, is generated. This is because the light amount adjustment data of the interpolation frame type is generated based on the two light amount adjustment data of the frame type that are in good harmonization with the two frame image data.

In other words, “interpolation” which is applied to the frame image data is also applied to the light amount adjustment data of the frame type. Because of this, if there is a good corresponding relationship in harmonization between the frame image data and the light amount adjustment data of the frame type, a good corresponding relationship in harmonization is also satisfied between the interpolation frame image data and the light amount adjustment data of the interpolation frame type.

And, the illumination device supplies light, which is based on the light amount adjustment data of the frame type that is in good harmonization with the interpolation frame image data, to a liquid crystal display panel and the like that display an image which is based on the interpolation frame image data. In this case, image blur, dynamic-image trouble (flicker feeling) and the like are unlikely to occur on the display image that is displayed on the liquid crystal display panel and the like. In other words, this illumination device is able to supply the light that does not allow image blur, dynamic-image trouble (flicker feeling) and the like from occurring on the display image that is displayed on the liquid crystal display panel and the like.

Here, it is desirable that the control unit changes contribution ratios of one and the other of the two light amount adjustment data of the frame type to generate the light amount adjustment data of the interpolation fame type.

Besides, it is desirable that in a case where the interpolation frame image data is generated in accordance with one highest contribution ratio of the one and the other of the two frame image data that are arranged in time series, the control unit generates the light amount adjustment data of the interpolation frame type in accordance with the highest contribution ratio of the one of the light amount adjustment data that corresponds to the one of the frame image data.

Besides, it is desirable that the control unit generates the light amount adjustment data of the frame interpolation type to the number of one or more.

Here, it is possible to say that a display device which includes the above illumination device and a display panel that displays an image in accordance with the image data is also the present invention. In detail, this display device is described in detail as follows.

In other words, the display device, besides the control unit, includes an image signal process portion and a liquid display panel controller. The image signal process portion separates the image data into panel control data and light source control data. The liquid display panel controller applies a process to the panel control data to generate, as the two frame image data, first frame image data and second frame image data that are arranged in time series; and generates the interpolation frame image data from the first frame image data and the second frame image data.

And, the control unit applies a process to the light source control data to generate, as the two light amount adjustment data of the frame type that are arranged in time series: first light amount adjustment data which corresponds to the first frame image data; and second light amount adjustment data which corresponds to the second frame image data. Further, the control unit generates the light amount adjustment data of the interpolation frame type from the first light amount adjustment data and the second light amount adjustment data.

Besides, in a data generation method for the illumination device that from the image data which is a base of the panel control data and the light source control data, generates the light amount adjustment data by applying a process to the light source control data, it is possible to say that the following method is also the present invention.

In other words, the data generation method, based on the panel control data, generates the light amount adjustment data of the frame type to the number of 2 while making the light amount adjustment data correspond to the two frame image data that are arranged in time series; and
from the two light amount adjustment data of the frame type, generates the light amount adjustment data of the interpolation frame type that corresponds to the intermediate interpolation frame image data in a time passage between the two frame image data.

Besides, in a data generation program for the illumination device that generates the light amount control data on the illumination device that includes:
the plurality of light sources that emit light in accordance with the light amount adjustment data; and
the control unit that from the image data which is a base of the panel control data and the light source control data, generates the light amount adjustment data by applying a process to the light source control data, it is possible to say that the following program is also the present invention.

In other words, the data generation program, based on the panel control data, generates the light amount adjustment data of the frame type to the number of 2 while making the light amount adjustment data correspond to the two frame image data that are arranged in time series; and
from the two light amount adjustment data of the frame type, generates the light amount adjustment data of the interpolation frame type that corresponds to the intermediate interpolation frame image data in a time passage between the two frame image data;
wherein the data generation program is executed by the control unit.

Here, it is possible to say that a computer-readable record medium that records the above data generation program is also the present invention.

### ADVANTAGEOUS EFFECTS OF INVENTION

According to the present invention, the “interpolation” which is applied to the panel control data contained in the image data is also applied to the light amount adjustment data that is based on the light source control data contained in the image data. And, a good corresponding relationship in harmonization is satisfied between the interpolation frame image data, which is generated from the two frame image data based on the panel control data, and the light amount adjustment data of the interpolation frame type which is generated from the two light amount adjustment data of the frame type based on the light source control data.

In this case, the illumination device supplies light, which is based on the light amount adjustment data of the frame type that is in good harmonization with the interpolation frame image data, to the liquid crystal display panel and the like that display an image which is based on the interpolation frame image data; and because of this, brightness unevenness, color unevenness and the like do not occur on the display image that is displayed on the liquid crystal display panel and the like. In other words, this illumination device supplies light distribution that does not allow image blur, dynamic-image trouble (flicker feeling) and the like from occurring on the display image that is displayed on the liquid crystal display panel and the like.

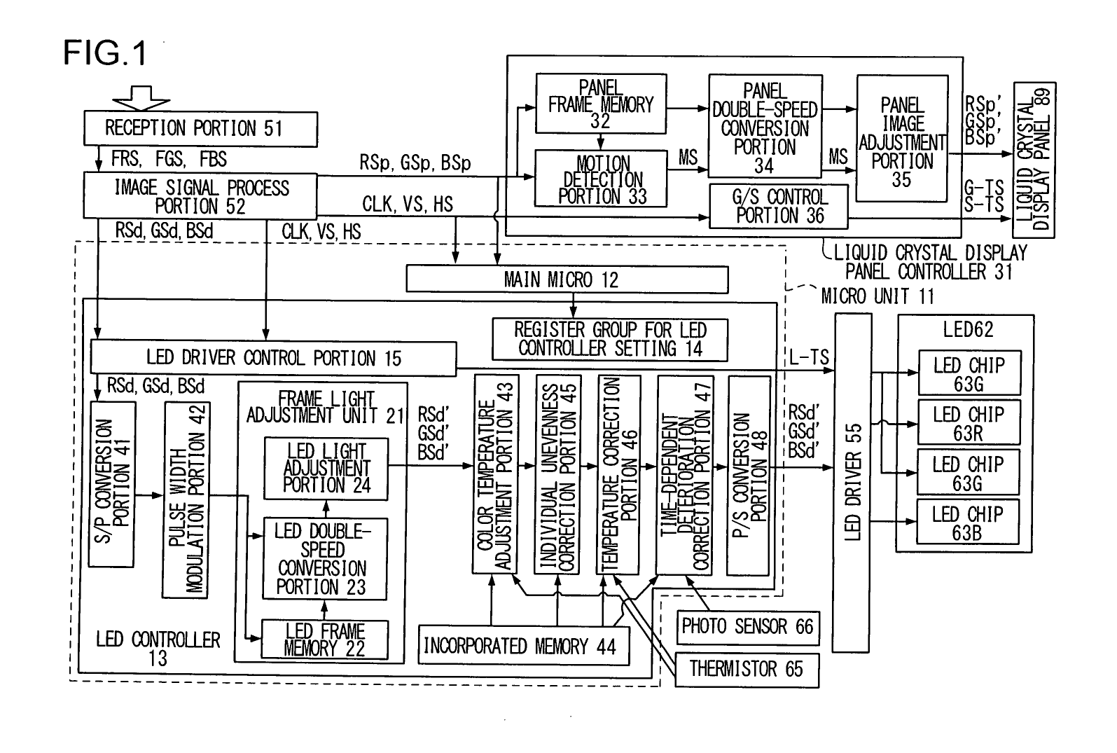

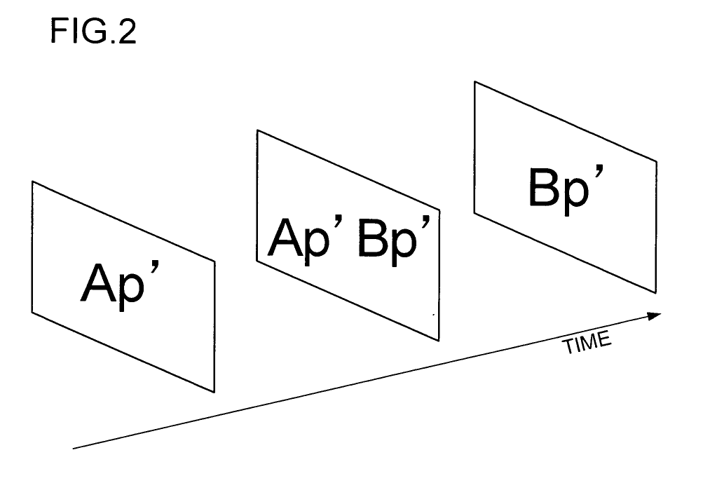

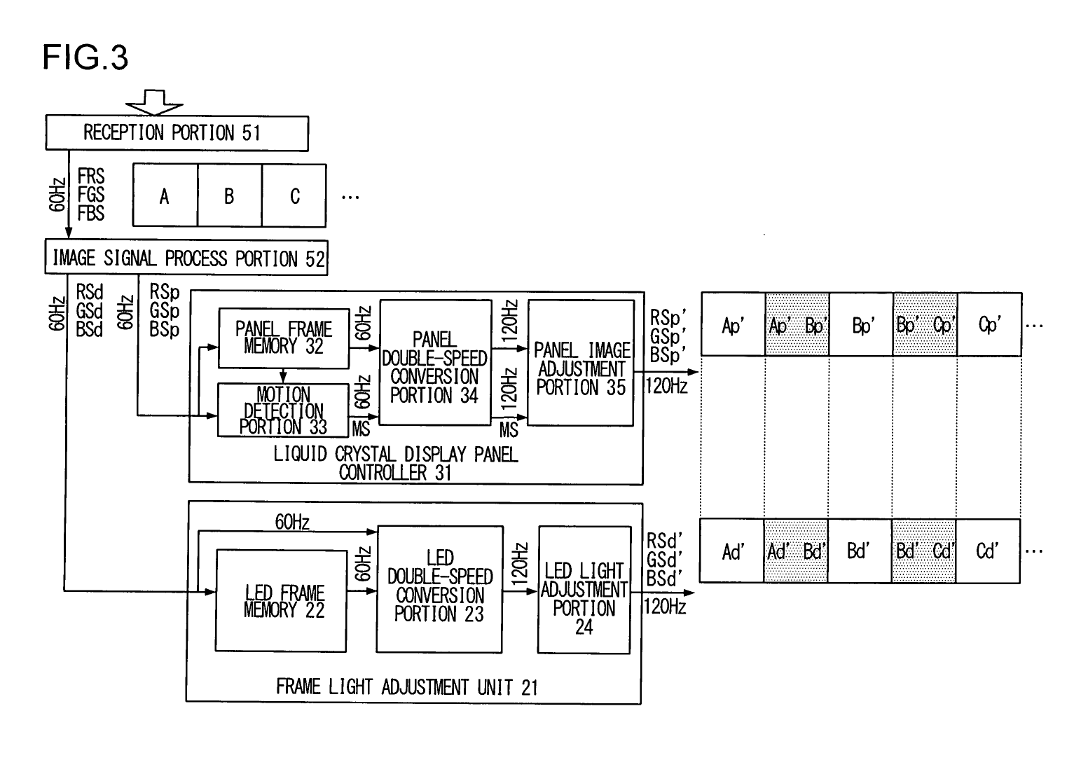

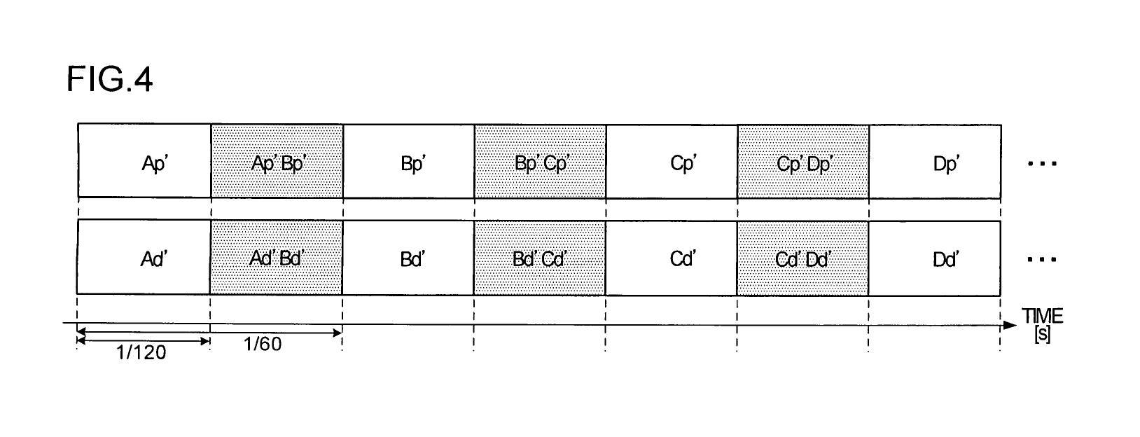

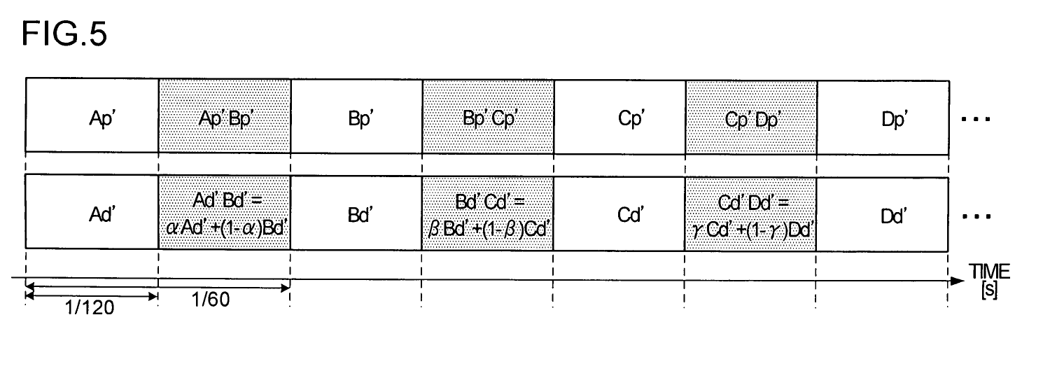

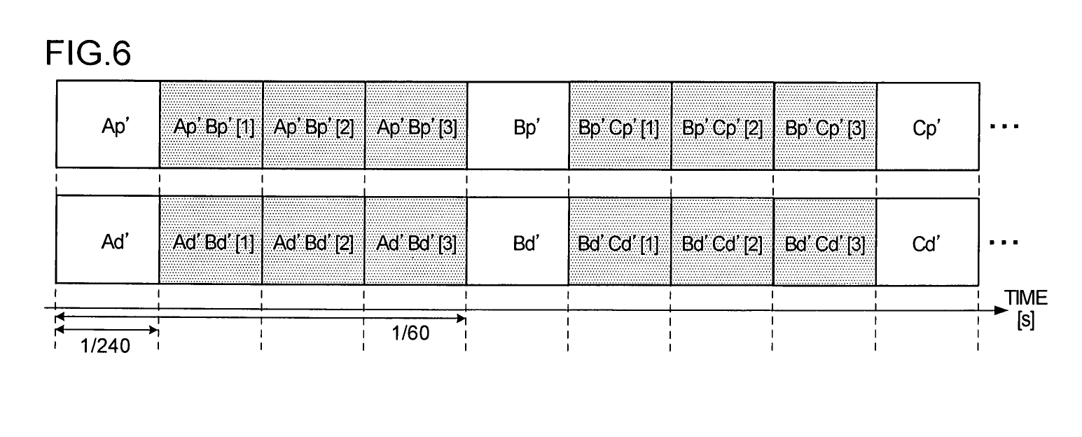

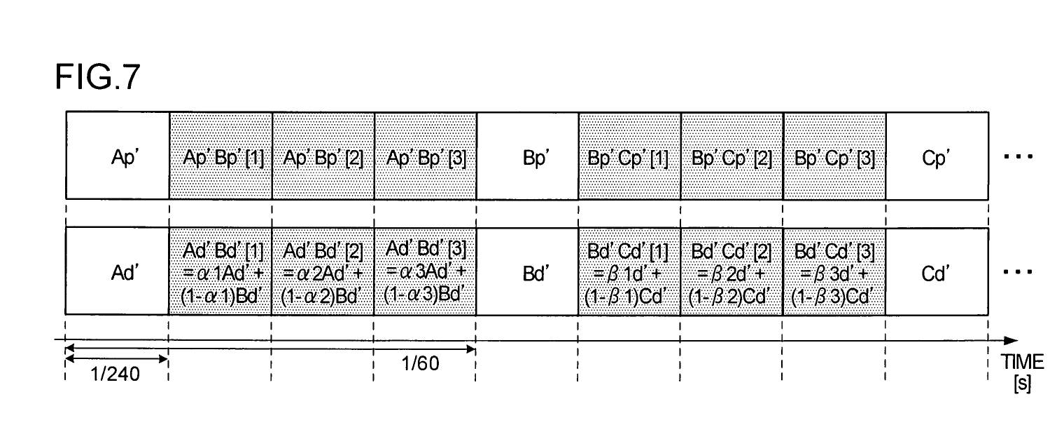

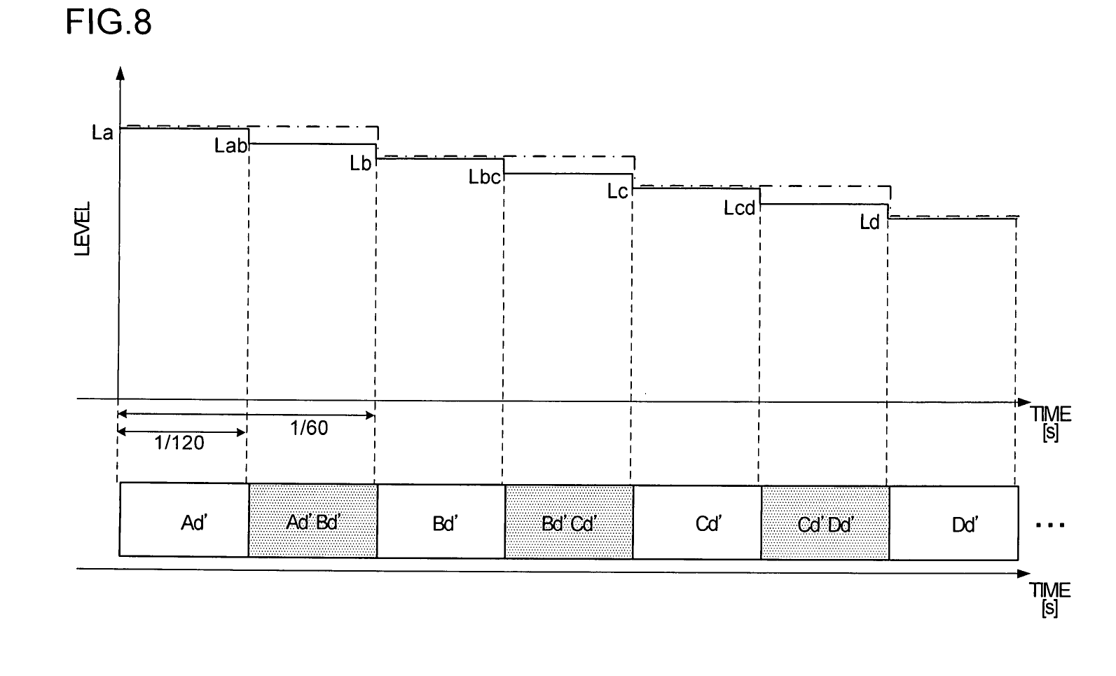

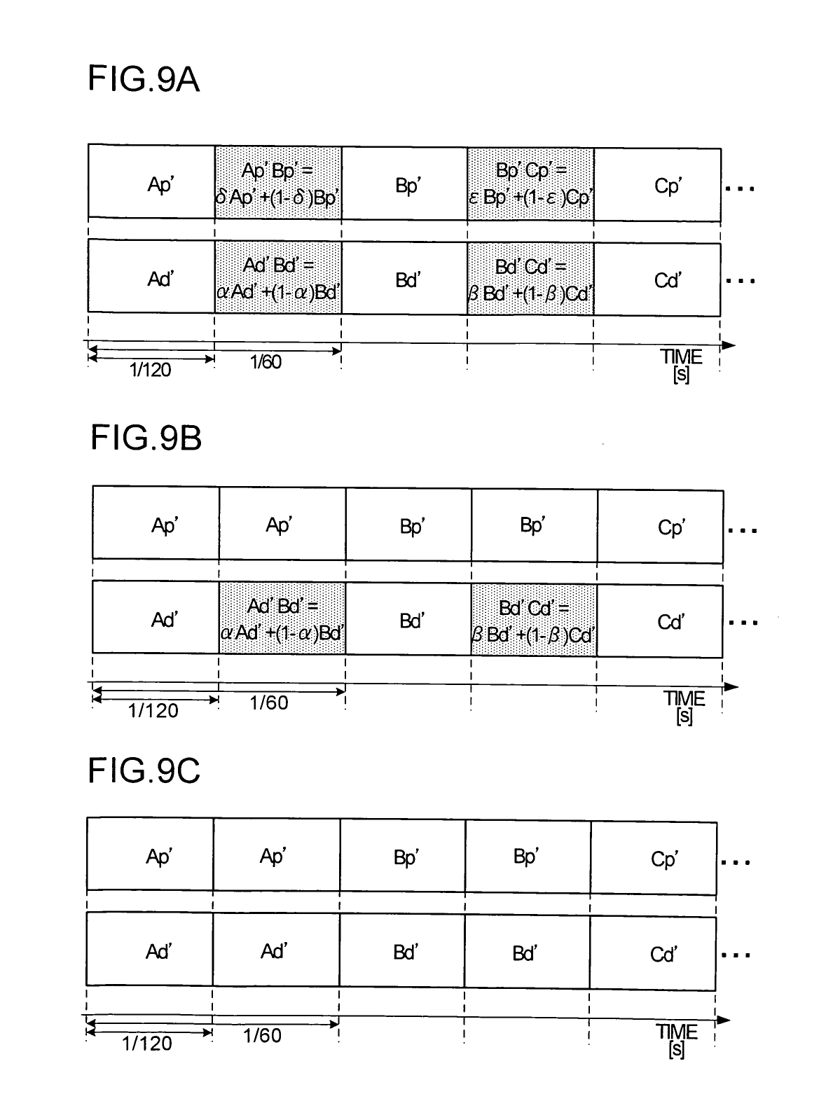

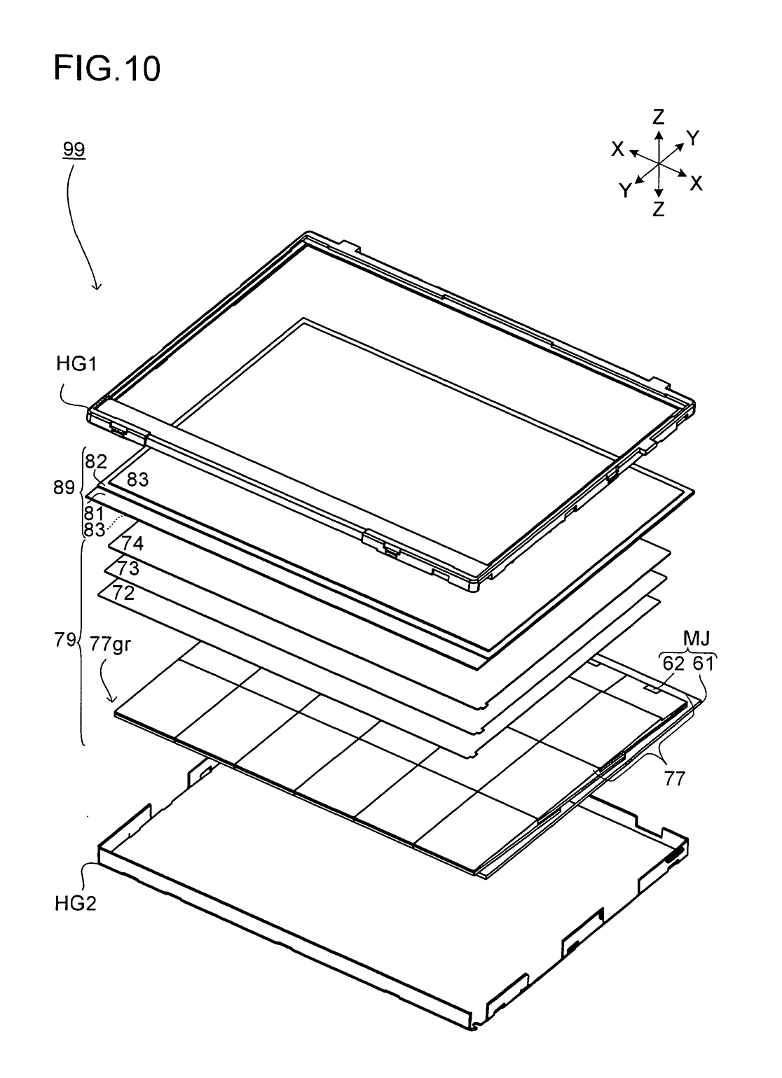

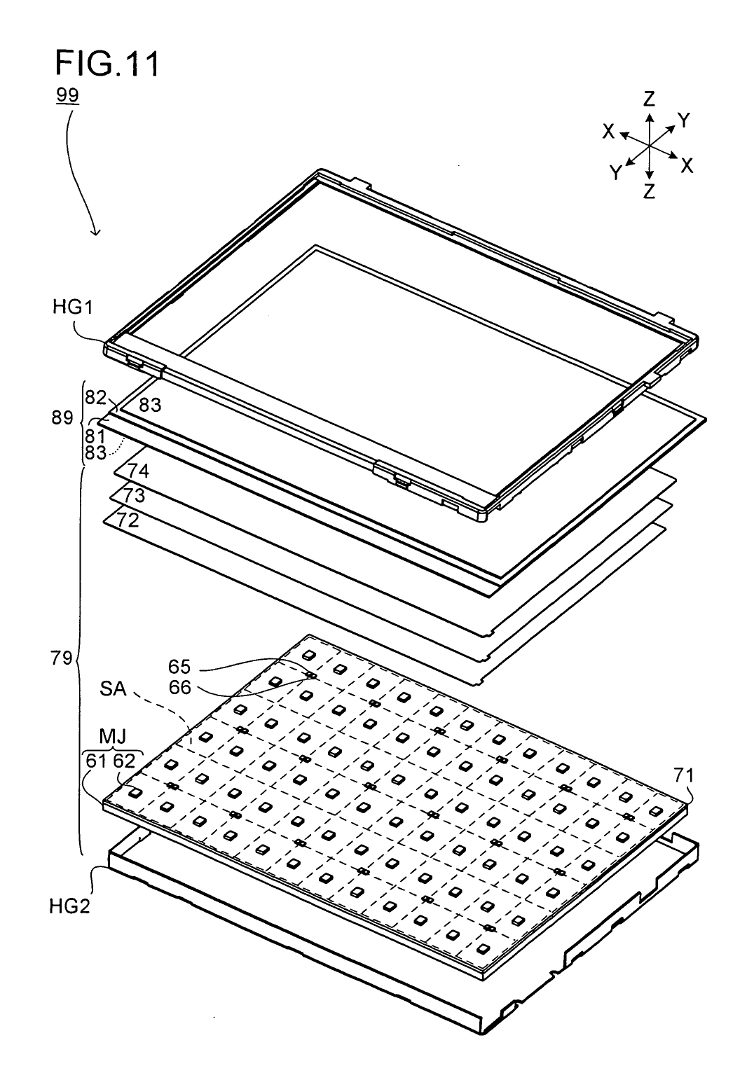

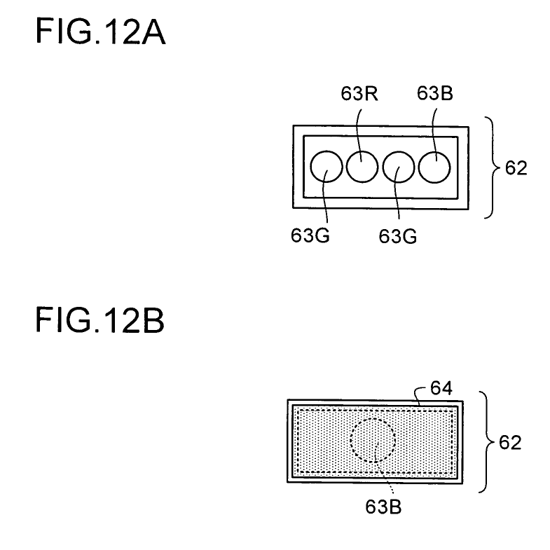

### BRIEF DESCRIPTION OF DRAWINGS

[FIG. 1] is a block diagram showing various members contained in a liquid crystal display device.

[FIG. 2] is a descriptive view in which a frame image signal and an interpolation frame image signal arranged in time series are schematized.

[FIG. 3] is a descriptive view in which the block diagram in FIG. 1 is simplified and various signals are schematized and arranged.

[FIG. 4] is a descriptive view in which a horizontal axis is use as a time axis and various signals are arranged in time series (here, the frame frequency is double-speeded).

[FIG. 5] is a descriptive view in which a contribution ratio of a frame-type LED control signal to an interpolation frame-type LED control signal is additionally represented in the descriptive view in FIG. 4.

[FIG. 6] is a descriptive view in which a horizontal axis is use as a time axis and various signals are arranged in time series (here, the frame frequency is speeded four times faster). [FIG. 7] is a descriptive view in which a contribution ratio of a frame-type LED control signal to an interpolation frame-type LED control signal is additionally represented in the descriptive view in FIG. 6.

[FIG. 8] is a descriptive view showing a light brightness level that corresponds to a frame-type LED control signal.

[FIG. 9A] is a descriptive view in which a contribution ratio of a frame image signal to an interpolation frame image signal is additionally represented in the descriptive view in FIG. 5.

[FIG. 9B] is a descriptive view showing that the interpolation frame image signal in FIG. 9A is substantially the frame image signal.

[FIG. 9C] is a descriptive view showing that the interpolation frame-type LED control signal in FIG. 9A is substantially the frame-type LED control signal.

[FIG. 10] is an exploded perspective view of a liquid crystal display device.

[FIG. 11] is an exploded perspective view of a liquid crystal display device.

[FIG. 12A] is a front view showing an LED that incorporates a plurality of LED chips.

[FIG. 12B] is a front view showing an LED that incorporates a single LED chip.

[FIG. 13A] is a descriptive view in which frame image signals and interpolation frame image signals, which are generated by a conventional liquid crystal display panel controller, are arranged.

[FIG. 13B] is a descriptive view in which frame-type LED control image signals, which correspond to a frame image signal and an interpolation frame image signal, are arranged in time series.

### DESCRIPTION OF EMBODIMENTS

### Embodiment 1

An embodiment is described based on drawings as follows. Here, for convenience, there are some cases where member references and the like are not indicated; in such cases, other drawings are referred to. Besides, although not a sectional view, for convenience, there are some cases where dot shading is applied. Besides, numerical embodiments described are only examples, and the numerical values are not limiting.

FIG. 11 is an exploded perspective view showing a liquid crystal display device (display device) 99. As shown in this FIG. 11, the liquid crystal display device 99 includes: a liquid crystal display panel (display panel) 89; a backlight unit (illumination device) 79; and a housing HG (HG1, HG2) that sandwiches them.

The liquid crystal display panel 89 employs an active matrix type. Because of this, in this liquid crystal display panel 89, liquid crystal (not shown) is sandwiched by an active matrix board 81 on which active elements such as not-shown TFTs (Thin Film transistor) and the like are disposed and an opposite board 82 that faces this active matrix board 81. In other words, the active matrix board 81 and the opposite board 82 are boards that are used to sandwich the liquid crystal and are formed of transparent glass and the like.

Here, on outer edges of the active matrix board 81 and the opposite board 82, not-shown seal members are disposed; theses seal members seal the liquid crystal. Besides, so as to sandwich the active matrix board 81 and the opposite board 82, light polarization films 83, 83 are disposed. Besides, a display image on this liquid crystal display panel 89 is controlled by a gate driver and a source driver that connect to the TFT and are not shown.

This liquid crystal display panel 89 is a non-light emitting display panel; accordingly, receives light (backlight) from the backlight unit 79 to fulfill the display function. Because of this, if the light from the backlight unit 79 is able to evenly shine onto the entire surface of the liquid crystal display panel 89, the display quality of the liquid crystal display panel 89 improves.

And, such backlight unit 79 includes: an LED module MJ; a thermistor (temperature measurement portion) 65; a photo sensor 66; a reflection sheet 71; a diffusion sheet 72; and prism sheets 73, 74.

The LED module includes a mount board 61 and an LED (Light Emitting Diode) 62. On the mount board 61, not-shown electrodes are disposed into a surface shape (e.g., a matrix shape); and on the electrodes, the LEDs (light sources, light emitting elements) 62 are mounted. And, the mount board 61 supplies an electric current, which flows from a not- shown power supply, to the LED 62 via the electrode.

The LED 62 is a point light source that receives the electric-current supply to emit light and is so disposed as to face the electrode on the mount surface of the mount board 61 (here, a direction of the light emitting surface of the LED 62 is the same as a direction of the mount surface where the electrodes are laid all over). As a result of this, the LEDs 62 are disposed on the mount surface of the mount board 61 into the surface shape and generate surface light. Here, as an example of the disposition, there is a rectangular- and matrix-shape surface disposition of the LED 62; and for convenience, a long direction of the rectangular shape is defined as an X direction while a short direction of the rectangular shape is defined as a Y direction.

Besides, the kind of the LED 62 is not especially limited. As an example, as shown in a front view of the LED 62 in FIG. 12A, there is the LED 62 in which one red light emitting (R) LED chip 63R, two green light emitting (G) LED chips 63G and one blue light emitting (B) LED chip 63B are disposed in parallel and white light is generated by color mixing.

Here, as another example, as shown in a front view of the LED 62 in FIG. 12B, there is the LED 62 that has a combination of the blue light emitting LED chip 63B and a fluorescent body 54 that receives blue light to emit yellow light (here, in the following description, unless otherwise specified, the LED 62 which generates the white light by means of the color mixing is used).

Besides, in such LED module MJ, it is possible to control the light emission of each of the LEDs 62. Because of this, it becomes possible to partially shine light onto a display region of the liquid crystal display panel 89. Here, FIG. 11 shows, by means of broken lines, shined regions SA that are controllable by the LEDs 62. In other words, one section (one of a plurality of sections arranged into a matrix shape) of the broken-line region is one of the shined regions SA controllable by one of the LEDs 62.

The thermistor 65 is a temperature sensor that is used to measure a temperature of the LED 62 and is mounted every four LEDs 62 on the mount board 61 (in detail, on the mount board 61, the thermistor 65 is mounted near a center of a region surrounded by the four LEDs 62).

The photo sensor 66 is a light measurement sensor for measuring a brightness of the LED 62 and, like the thermistor 65, is mounted every four LEDs 62 on the mount board 61.

The reflection sheet 71 is a reflection member that is attached to the mount surface of the mount board 61 avoiding the LED 62, the thermistor 65 and the photo sensor 66; and has a reflection surface on the same side of the light emitting side of the LED 62. Because of this, even if part of the light from the LED 62 travels toward the mount surface of the mount board 61, the light is reflected by the reflection surface of the reflection sheet 71.

The diffusion sheet 72 is so situated as to cover the LEDs 62 arranged in the matrix shape; diffuses the surface light formed by the light from the LEDs 62 to spread the light throughout the entire region of the liquid crystal display panel 89 (here, this diffusion sheet 72 and the prism sheets 73, 74 are also collectively called an optical sheet group (72 to 74)).

The prism sheets 73, 74 are optical sheets that have, for example, prism shapes in a sheet surface, deflect a radiation characteristic of light and are so situated as to cover the diffusion sheet 72. Because of this, the prism sheets 73, 74 collect the light traveling from the diffusion sheet 72 to improve the brightness. Here, the diffusion directions of the light collected by the prism sheet 73 and the prism sheet 74 are in a relationship to intersect each other.

And, in the above backlight unit 79, the surface light from the LED 62 passes through the optical sheet group (72 to 74), turns into the backlight whose brightness is increased and exits. And, this backlight reaches the liquid crystal display panel 89; and by means of the backlight, the liquid crystal display panel 89 displays an image.

Next, the housing HG is described. A front housing HG1 and a rear housing HG2 of the housing HG sandwich and fix the above backlight unit 79 and the liquid crystal display panel 89 that covers the backlight unit 79 (here, the fixing method is not especially limited). In other words, the front housing HG1 collaborates with the rear housing HG2 to sandwich the backlight unit 79 and the liquid crystal display panel 89; because of this, the liquid crystal display device 99 is completed.

Here, on the rear housing HG2, the LED module MJ, the reflection sheet 71, the diffusion sheet 72 and the prism sheets 73, 74 are stacked in this order and the stacked direction is called a Z direction (here, it is desirable that the X direction, the Y direction and the Z direction are in a relationship to intersect each other at right angles).

In the meantime, as described above, the backlight unit 79, in which the plurality of LEDs 62 are disposed into the matrix shape, is able to control the output light from each LED 62; and because of this, able to partially shine light onto the display region of the liquid crystal display panel 89. Because of this, such backlight unit 79 is also able to be called the backlight unit 79 of an active area type.

Here, the light emission control by the backlight unit 79 of the active area type is described. FIG. 1 is a block diagram showing various members contained in the liquid crystal display device 99 (here, the LED 62 shown in FIG. 1 is one of the plurality of LEDs 62).

As shown in FIG. 1, the liquid crystal display device 99 includes: a reception portion 51; an image signal process portion 52; a liquid crystal display panel controller 31; a main microcomputer (main micro) 12; an LED controller 13; the thermistor 65; the photo sensor 66; an LED driver 55; and the LED 62.

The reception portion 51 receives, for example, an image voice signal such as a television broadcast signal (see a white arrow) and the like (in the following description, an image signal contained in the image voice signal is chiefly described). And, the reception portion 51 transmits the received image signal to the image signal process portion 52.

Here, the image signal transmitted to the image signal process portion 52 is, for convenience, defined as a basic image signal (image data); and of color image signals contained in this basic image signal, a signal for indicating a red color is defined as a basic red color image signal FRS; a signal for indicating a green color is defined as a basic green color image signal FGS; and a signal for indicating a blue color is defined as a basic blue color image signal FBS.

The image signal process portion 52, based on the received basic image signal (image data), generates a processed image signal. And, the image signal process portion 52 transmits the processed image signal to the liquid crystal display panel controller 31 and the LED controller 13.

Here, the processed image signal is: a processed color image signal (processed red color image signal RS, processed green color image signal GS, processed blue color image signal BS) that is obtained by processing the basic color image signal (basic red color image signal FRS, basic green color image signal FGS, basic blue color image signal FBS and the like); and a synchronization signal (clock signal CLK, vertical synchronization signal VS, horizontal synchronization signal HS and the like) that is related to the processed color image signal.

However, the processed color image signal transmitted to the liquid crystal display panel controller 31 and the processed color image signal transmitted to the LED controller 13 are different from each other. Accordingly, to distinguish these processed color image signals from each other, the processed color image signal (panel control data) transmitted to the liquid crystal display panel controller 31 is defined as a panel processed red color image signal RSp, a panel processed green color image signal GSp, and a panel processed blue color image signal BSp.

On the other hand, the processed color image signal (light source control data) transmitted to the LED controller 13 is defined as a light source red color image signal RSd, a light source green color image signal GSd, and a light source blue color image signal BSd (here, in detail, the light source color image signal (RSd, GSd, BSd) undergoes processes such as interpolation and the like; thereafter, is transmitted to the LED driver 55, which is described in detail later.

Based on the panel processed red color image signal RSp, the panel processed green color image signal GSp, the panel processed blue color image signal BSp, and the synchronization signal related to these signal, the liquid crystal display panel controller 31 controls the pixels of the liquid crystal display panel 89.

Here, the liquid crystal display panel controller 31 has a function for inserting another screen between one (one frame) of a series of screens and the next, that is, a generation function for generating a so-called interpolation frame. To have such a function, the liquid crystal display panel controller 31, as shown in FIG. 1, includes: a panel frame memory 32; a motion detection portion 33; a panel double-speed conversion portion 34; a panel image adjustment portion 35; and a gate driver/source driver control portion (G/S control portion) 36.

The panel frame memory 32 stores one-frame part of the panel processed color image signal (RSp, GSp, BSp) (here, the panel processed color image signal corresponding to one frame is called a frame image signal (frame image data)). And, in a case where the frame frequency is 60 Hz, the panel frame memory 32 reads 60-frame part of the stored panel processed color image signal per second; delays the part by one frame period (one vertical scan period); and transmits the delayed part to the motion detection portion 33 and the panel double-speed conversion portion 34.

The motion detection portion 33 uses the panel processed color image signal transmitted without passing through the panel frame memory 32 and the delayed panel processed color image signal transmitted via the panel frame memory 32 to detect a signal that indicates a motion vector (motion vector signal MS) by means of a block matching method. And, the motion detection portion 33 transmits the detected motion vector signal MS to the panel double-speed conversion portion 34.

The panel double-speed conversion portion 34 double-speeds the panel processed color image signal transmitted from the panel frame memory 32 while double-speeding the motion vector signal MS transmitted from the motion detection portion 33. And, these double-speeded signals (the signal obtained by double-speeding the panel processed color image signal (RSp, GSp, BSp) and the signal obtained by double-speeding the motion vector signal MS) are transmitted to the panel image adjustment portion 35 by the panel double-speed conversion portion 34.

The panel image adjustment portion 35, based on the motion vector signal MS, generates a signal (interpolation image) for an interpolation frame image from the panel processed color image signal (RSp, GSp, BSp); and inserts the interpolation frame image signal between usual frame image signals. And, the panel image adjustment portion 35 transmits these signals (the interpolation frame image signal and the usual frame image signal that is not the interpolation frame image signal) to a source driver of the liquid crystal display panel 89.

For example, as shown in FIG. 2, when a frame image signal and the next frame image signal that are arranged in time series are “Ap′”, and “Bp′” respectively, the panel image adjustment portion 35, by means of these frame image signal “Ap′” and frame image signal “Bp′”, generates an interpolation frame image signal to be inserted between the frame image signal “Ap′” and the frame image signal “Bp′” (here, such an interpolation frame image signal is based on the frame image signal “Ap′” and the frame image signal “Bp′”, so that the interpolation frame image signal is expressed as an interpolation frame image signal Ap′Bp′).

And, the panel image adjustment portion 35 transmits these frame image signals (first frame image data) Ap′, the interpolation frame image signal (interpolation frame image data) Ap′Bp′, and the frame image signal (second frame image data) Bp′to the source driver.

Here, the mark “′” is also attached to the panel processed color image signals (RSp, GSp, BSp) that correspond to the frame image signal Ap′, the interpolation frame image signal Ap′Bp′ and the frame image signal Bp′ (panel processed color image signals (RSp′, GSp′, BSp′)). In other words, the mark “′” is attached to the panel processed color image signals (RSp, GSp, BSp) that are processed by the liquid crystal display panel controller 31.

Beside, the frame image signals generated from the basic color image signals (FRS, FGS, FBS) may be so expressed as frame image signals A, B, C . . . as to correspond to the frame image signal Ap′, the frame image signal Bp′, . . . . Here, the block diagram in FIG. 1 that is simplified and the various frame image signals that are schematized are shown together as in FIG. 3.

The gate driver/source driver control portion (G/S control portion) 36, as shown in FIG. 1, generates timing signals for controlling the gate driver and the source driver from the clock signal CLK, the vertical synchronization signal VS, the horizontal synchronization signal HS and the like that are transmitted from the image signal process portion 52 (here, the timing signal corresponding to the gate driver is defined as “G-TS”, while the timing signal corresponding to the source driver is defined as “S-TS”).

In other words, the liquid crystal display panel controller 31, as shown in FIG. 1, generates the panel processed color image signals (RSp′, GSp′, BSp′) and the timing signals (G-TS, S-TS); and by means of these signals, controls the liquid crystal display panel 89.

The main microcomputer (main micro) 12 integrates various control of the backlight unit 79, the liquid crystal display panel 89 and the like. Here, the main micro 12 and the LED controller 13 controlled by the main micro 12 are collectively called a micro unit 11 in some cases.

The LED controller 13, under the management (control) by the main micro 12, transmits various control signals to the LED driver 55. And, this LED controller 13 includes: an LED controller setting register group 14; an LED driver control portion 15; a serial parallel conversion portion (S/P conversion portion) 41; a pulse width modulation portion 42; a frame light adjustment unit 21; a color temperature correction portion 43; an incorporated memory 44; an individual unevenness correction portion 45; a temperature correction portion 46; a time-dependent deterioration correction portion 47; and a parallel serial conversion portion (P/S conversion portion) 48.

The LED controller setting register group 14 temporarily holds various control signals from the main micro 12. In other words, the main micro 12 controls various members in the inside of the LED controller 13 via the LED controller setting register group 14.

The LED driver control portion 15 transmits the light source color image signals (RSd, GSd, BSd) from the image signal process portion 52 to the S/P conversion portion 41. Besides, the LED driver control portion 15, by means of the synchronization signals (the clock signal CLK, the vertical synchronization signal VS, the horizontal synchronization signal and the like), generates a timing signal L-TS for turning on the LED 62 (in detail, the LED chip 63) and transmits the timing signal to the LED driver 55.

The S/P conversion portion 41 converts the light source color image signal transmitted as serial data from the LED driver control portion 15 into parallel data.

The pulse width modulation portion 42, based on the light source color image signal, adjusts the light emission period of the LED 62 by means of a pulse width modulation method (Pulse Width Modulation: PWM). Besides, a signal value used for such pulse width modulation is called a PWM signal (PWM value). Here, the pulse width modulation method is a method that is well known and separates one second into 128 sections and changes a time width for emitting light in each section (e.g., changes the light emission time by means of PWM values of 12 bits=0 to 4095).

The frame light adjustment unit 21 adjusts the light source color image signals (RSd, GSd, BSd) to obtain signals that correspond to the frame image signal and the interpolation frame image signal that are generated from the panel processed color image signals (RSp, GSp, BSp). However, details are described later.

The color temperature adjustment portion 43 performs correction to make the color temperature of the white light emitted from the LED 62 come close to a desired value. For example, the color temperature adjustment portion 43, by means of a data table that contains the temperature of each of the LED chips (63R, 63G, 63B) and the brightness of each of the LED chips that corresponds to the temperature, calculates the brightness of the white light from the brightness ratio of the respective light (red light, green light, blue light) that constitutes the white light (here, the temperature of each of the LED chips 63 is measured by the thermistor 65).

And, the color temperature adjustment portion 43 adjusts and makes the calculated brightness of the white light come close to a desired brightness of the white light. Specifically, the color temperature adjustment portion 43 changes the value of an electric current that flows in each of the LED 62. However, the way of the color temperature adjustment performed by the color temperature adjustment portion 43 is not limited to the above way: another way of the color temperature adjustment may be employed. Here, the data table, which contains the temperature of each of the LED chips (63R, 63G, 63B) and the brightness of each of the LED chips, is stored in the incorporated memory 44.

The incorporated memory 44 stores, for example, the data table that is necessary for the above color temperature adjustment. Besides, the incorporated memory 44 stores a look-up table (LUT) as well that is necessary for the individual unevenness correction portion 45, the temperature correction portion 46, and the time-dependent deterioration correction portion 47 that are on later stages after the color temperature adjustment portion 43.

The individual unevenness correction portion 45 confirms the performance of each of the LEDs 62 in advance and performs correction to remove individual differences. For example, in advance, the brightness of the LED 62 is measured by means of specific PWM values. In detail, the specific PWM value corresponding to each of the LED chips 63 is corrected such that the red light emitting LED chip 63R, the green light emitting LED chip 63G, and the blue light emitting LED chip 63B of each of the LED 62 are turned on to be able to generate the white light that has a desired tint.

Next, the PWM value corresponding to each of the LEDs 62 (the LED chips 63R, 63G, 63B) is further corrected such that the plurality of LEDs 62 are turned on to remove brightness unevenness of the surface light. According to this, the individual differences (individual unevenness of the brightness, and brightness unevenness of the surface light) in the plurality of LEDs 62 are corrected.

Here, there are various ways of performing such correction process; however, a correction process that uses a general look-up table (LUT) is employed. In other words, the individual unevenness correction portion 45 performs a correction process by means of a LUT that is stored in the incorporated memory 44 and is for the individual unevenness of the LED 62.

The temperature correction portion 46 performs a correction process considering brightness deterioration of the LED 62 caused by temperature increase due to the light emission from the LED 62. For example, the temperature correction portion 46 obtains temperature data of the LED 62 (in short, the LED chips 63R, 63G, 63B) by means of the thermistor 65 once every second; obtains a LUT corresponding to the temperature data from the incorporated memory 44; and performs a correction process (in other words, changes the PWM values that correspond to the LED chips 63R, 63G, 63B) to curb the brightness unevenness of the surface light.

The time-dependent deterioration correction portion 47 performs a correction considering the brightness deterioration of the LED 62 caused by time-dependent deterioration of the LED 62. For example, the time-dependent deterioration correction portion 47 obtains brightness data of the LED 62 (in short, the LED chips 63R, 63G, 63B) by means of the photo sensor 66 once every year; obtains a LUT corresponding to the brightness data from the incorporated memory 44; and performs a correction process (in other words, changes the PWM values that correspond to the LED chips 63R, 63G, 63B) to curb the brightness unevenness of the surface light.

The P/S conversion portion 48 converts the light source color image signal, which undergoes various correction processes and is transmitted as parallel data, into serial data.

The LED driver 55, based on the signal (the PWM signal, the timing signal) from the LED controller 13, performs the turning on/off control of the LED 62.

The LED 62, as described above, includes: the one LED chip 63R; the two LED chips 63 G; and the one LED chip 63B. And, the turning on/off control of theses LED chips (light emitting chips) is performed by the LED driver 55 by means of the pulse width modulation system.

Here, the frame light adjustment unit 21 is described in detail using FIG. 1 to FIG. 8. The frame light adjustment portion 21, as shown in FIG. 1 and FIG. 3, includes: an LED frame memory 22; an LED double-speed conversion portion 23; and an LED light adjustment portion 24 (here, the frequency 60 Hz shown in FIG. 3 is an example and is not limited to this).

LED frame memory 22 stores one-fame part of the light source color image signal (RSd, GSd, BSd) (here, the light source color image signal for one frame is called a frame-type LED control signal). And, in a case where the fame frequency is, for example, 60 Hz, the LED frame memory 22 reads 60-frame part of the stored light source color image signal every second; delays the part by one frame period (one vertical scan period); and transmits the delayed part to the LED double-speed conversion portion 23.

The LED double-speed conversion portion 23 double-speeds the light source color image signal (usual light source color image signal) that is not delayed without passing though the LED frame memory 22 while double-speeding the delayed light source color image signal that is transmitted from the LED frame memory 22. And, these double-speeded signals (the signal obtained by double-speeding the not-delayed panel processed color image signal and the signal obtained by double- speeding the delayed panel processed color image signal) are transmitted to the LED light adjustment portion 24 by the LED double-speed conversion portion 23.

The LED light adjustment portion 24 adjusts the two kinds of double-speeded signals transmitted to obtain signals that correspond to the frame image signal and the interpolation frame image signal that are adjusted by the liquid crystal display panel controller 31. In detail, the LED light adjustment portion 24 inserts the light source color image signal, which corresponds to the interpolation frame image signal, between the light source color image signals which correspond to the usual frame image signal (here, the light source color image signal corresponding to the usual frame image signal is called the frame-type LED control signal while the light source color image signal corresponding to the interpolation frame image signal is called the interpolation frame-type LED control signal).

For example, the frame-type LED control signal (frame-type light amount adjustment data, first light amount adjustment data) corresponding to the frame image signal Ap′ is defined as “Ad′”; and the frame-type LED control signal (frame-type light amount adjustment data, second light amount adjustment data) corresponding to the frame image signal Bp′ is defined as “Bd′”.

Further, the interpolation frame-type LED control signal (interpolation frame- type light amount adjustment data) corresponding to the interpolation frame image signal Ap′Bp′ is defined as “Ad′Bd′”. And, FIG. 3 shows the frame-type LED control signal Ad′, the interpolation frame-type LED control signal Ad′Bd′, the frame-type LED control signal Bd′ and the like.

In other words, the LED light adjustment portion 24 generates the frame-type LED control signal Ad′Bd′ that corresponds to the interpolation frame image signal Ap′Bp′; and inserts the interpolation frame-type LED control signal Ad′Bd′ between the frame-type LED control signal Ad′ and the frame-type LED control signal Bd′. And, the LED light adjustment portion 24 transmits these signals (the interpolation frame-type LED control signal and the frame-type LED control signal) to the color temperature adjustment portion 43.

Here, as shown in FIG. 3 and later-described FIG. 4, the micro unit 11 synchronizes, for example, the frame-type LED control signal Ad′ with the frame image signal Ap′; synchronizes the interpolation frame-type LED control signal Ad′Bd′ with the interpolation frame image signal Ap′Bp′; and synchronizes the frame-type LED control signal Bd′ with the frame image signal Bp′. In other words, the micro unit 11 synchronizes the frame-type LED control signal and the interpolation frame-type LED control signal with the frame image signal and the interpolation frame image signal respectively that are in a corresponding relationship.

Besides, the mark “′” is also attached to the light source image signals (RSd, GSd, BSd) that correspond to the frame-type LED control signal Ad′, the interpolation frame-type LED control signal Ad′Bd′, the frame-type LED control signal Bd′ and the like (the light source color image signals (RSd′, GSd′, BSd′)). In other words, the mark “′” is attached to the light source color image signals (RSd, GSd, BSd) that are processed by the frame light adjustment portion 21 (here, the light source color image signal after such process is also called the light amount adjustment data).

The above description is summed up as follows. In other words, under the management by the main micro 12, the frame light adjustment unit 21 of the LED controller 13, to perform the process, receives the light source color image signals (RSd, GSd, BSd) from the basic color image signals (image data) that are bases of the panel processed color image signal (panel control data) and the light source color image signal (light source control data).

And, under the management by the main micro 12, the LED controller 13 (in other words, the micro unit 11), based on the panel processed color image signals (RSp, GSp, BSp), generates two frame-type LED control signals while making the frame-type LED control signals correspond to the two frame image signals that are arranged in time series. Further, the LED controller 13, from the two frame-type LED control signals, generates the interpolation frame-type LED signal that corresponds to the intermediate interpolation frame image signal in a time passage between the two frame image signals.

As a specific example, under the management by the main micro 12, the LED controller 13, based on the panel processed color image signals (RSp, GSp, BSp), generates the two frame-type LED control signals Ad′ and Bd′ while making the frame-type LED control signals correspond to the two frame image signals Ap′ and Bp′ that are arranged in time series.

Further, the LED controller 13, from the two frame-type LED control signals Ad′ and Bd′, generates the interpolation frame-type LED control signal Ad′Bd′ that corresponds to the intermediate interpolation frame image signal Ap′Bp′ in a time passage between the two frame image signals Ap′ and Bp′.

And, FIG. 4 is a descriptive view in which the frame-type LED control signal Ad′, the interpolation frame-type LED control signal Ad′Bd′, the frame-type LED control signal Bd′ and the like, which are described as examples, correspond to the frame image signal Ap′, the interpolation frame image signal Ap′Bp′, the frame image signal Bp′ and the like (FIG. 4 is a descriptive view in which a horizontal axis is used as a time axis (second; s) and the various signals are arranged in time series).

Usually, the panel processed color image signals (RSp′, GSp′, BSp′), which become the frame image signals Ap′, Bp′, Cp′, Dp′ . . . that are arranged in time series, originate from the bases, that is, the panel processed color image signals (RSp, GSp, BSp); and these panel processed color image signals (RSp, GSp, BSp) constitute the basic color image signals (FRS, FGS, FBS).

On the other hand, the light source color image signals (RSd′, GSd′, BSd′), which become the frame-type LED control signals Ad′, Bd′, Cd′, Dd′ . . . that are arranged in time series, originate from the bases, that is, the light source color image signals (RSd, GSd, BSd); and these light source color image signals (RSd, GSd, BSd) also constitute the basic color image signals (FRS, FGS, FBS).

It is possible to say that a correlation between the signals which have the same constituent bases as described above is high; and because of this, the frame image signals Ap′, Bp′, Cp′, Dp′ . . . arranged in time series and the frame-type LED control signals Ad′, Bd′, Cd′, Dd′ . . . arranged in time series are in good harmonization (matching) with each other. The matching means that for example, in a case where the frame image signal is displayed on the liquid crystal display panel 89, the frame-type LED control signal functions such that light (backlight), which generates as less image blur, dynamic-image trouble (flicker feeling) and the like as possible, is obtained.

As can be seen from FIG. 4, the frame image signals Ap′, Bp′, Cp′, Dp′ . . . and the frame-type LED control signals Ad′, Bd′, Cd′, Dd′ . . . have the same timing in terms of time (synchronize with each other). Accordingly, in the case where the frame image signals Ap′, Bp′, Cp′, Dp′ . . . are displayed on the liquid crystal display panel 89, the display image receives the light that is based on the frame-type LED control signals Ad′, Bd′, Cd′, Dd′ . . . which are in good harmonization with the frame image signals Ap′, Bp′, Cp′, Dp′ . . . , so that the display image becomes a relatively high-quality image.

Besides, the interpolation frame-type LED control signals, which have the same timing as the interpolation frame image signals Ap′Bp′, Bp′Cp′, Cp′Dp′ . . . , are the interpolation frame-type LED control signals Ad′Bd′, Bd′Cd′, Cd′Dd′ . . . . These interpolation frame-type LED control signals Ad′Bd′, Bd′Cd′, Cd′Dd′, . . . are not the the frame-type LED control signals Ad′, Bd′, Cd′, Dd′ . . . themselves, but the signals that are generated based on the the frame-type LED control signals Ad′, Bd′, Cd′, Dd′ . . . .

And, like the generation of the interpolation frame image signal, the interpolation frame-type LED control signal is generated based on one and the other of the frame-type LED control signals that are arranged in time series. For example, the interpolation frame image signal Ap′Bp′ is generated based on the frame image signal Ap′ and the frame image signal Bp′; likewise, the interpolation frame-type LED control signal Ad′Bd′ is generated based on the frame-type LED control signal Ad′ and the frame-type LED control signal Bd′.

In other words, the interpolation frame image signal Ap′Bp′, which is based on the frame image signal Ap′ and the frame image signal Bp′, corresponds to the interpolation frame-type LED control signal Ad′Bd′ that is ₐbased on the frame-type LED control signal Ad′ and the frame-type LED control signal Bd′ that are in good harmonization with the frame image signal Ap′ and the frame image signal Bp′.

Because of this, the interpolation frame image signal and the interpolation frame-type LED control signal, which controls the LED 62 that emits light at the same timing with the interpolation frame signal, have a correlation with each other; and because of this, the harmonization between the interpolation frame image signal and the interpolation frame-type LED control signal also becomes relatively high. As a result of this, in a case where the interpolation frame image signal is displayed on the liquid crystal display panel 89, the display image also becomes a relatively high-quality image like in the case where the frame image signal is displayed on the liquid crystal display panel 89.

In short, the “interpolation” (from two frame image signals before and after, a frame image signal that is suitable between both of the frame image signals is imagined and prepared) that is applied to the usual frame image signal is applied to the frame-type LED control signal as well.

In detail, from two frame-type LED control signals before and after, a frame-type LED control signal that is suitable between both of the frame-type LED control signals is imagined and prepared. And, the frame image signal and the frame-type LED control signal are in good harmonization with each other, so that the harmonization between the interpolation frame image signal and the interpolation frame-type LED control signal also becomes good.

In other words, between the image signal (the frame image signal and the interpolation frame image signal) displayed on the liquid crystal display panel 89 and the LED control signal (the frame-type LED control signal and the interpolation frame-type LED control signal) that controls the backlight of the backlight unit 79, a good relationship in harmonization is satisfied. As a result of this, by means of such process “interpolation” only, the quality of the image displayed on the liquid crystal display panel 89 improves.

Here, in the process for generating the interpolation frame-type LED control signal, the contribution ratios (e.g., α, β, γ . . . ) of one and the other of the two frame-type LED control signals may suitably change. FIG. 5 is a descriptive view which describes, additionally to the descriptive view of FIG. 4, the contribution ratios α, β, γ . . . (here, α, β, γ . . . are numbers equal to 1 or smaller) of the frame-type LED control signal to the interpolation frame-type LED control signal.

As shown in FIG. 5, for example, the interpolation frame-type LED control signal Ad′Bd′ is composed by summation of (α×100) % of the frame-type LED control signal Ad′ and ((1−α)×100) % of the frame-type LED control signal Bd′. And, the contribution ratio a is suitably changed in accordance with the interpolation frame image signal Ap′Bp′.

For example, in a case where the interpolation frame image signal Ap′Bp′ is generated by means of the contribution of the frame image signal Ap′ larger than the frame image signal Bp′, it is desirable that the interpolation frame-type LED control signal Ad′Bd′ also is generated by the contribution of the frame-type LED control signal Ad′ larger than the frame-type LED control signal Bd′ (in other words, it is desirable that a relationship α>(1−α) is satisfied).

According to this, the interpolation frame-type LED control signal, which is in good harmonization with the interpolation frame image signal, is generated. Because of this, the display image on the liquid crystal display panel 89, which is based on the interpolation frame image signal that corresponds to the interpolation frame-type LED control signal, receives the backlight that is based on the interpolation frame-type LED control signal which is in good harmonization with the interpolation frame image, so that the display image has a relatively high quality.

Here, the contribution ratios (e.g., α, β, γ . . . ) may suitably change for each of the LED chips 63R, 63G, and 63B. This is because, according to this, a frame-type LED control signal that is in better harmonization with the interpolation frame image signal is generated. Here, not limited to this, in a case of the LED 63 as shown in FIG. 12B, the contribution ratio may change for each LED 63.

In the meantime, as an example of the frame frequency, 60 Hz of an NTSC (National Television System Committee) system is described; however, this is not limiting. For example, the frame frequency may be 50 Hz of a PAL (Phase Alternating Line) system.

Besides, as shown in FIG. 3, the panel double-speed conversion portion 34 of the liquid crystal display panel controller 31 and the LED double-speed conversion portion 23 of the LED controller 13 (in detail, the frame light adjustment unit 21) double-speed a signal (60 Hz→120 Hz); however, this is not limiting. For example, both double-speed conversion portions 34, 23 may speed a signal four times faster or more (60 Hz→240 Hz).

For example, in a case of four-time faster speed, as shown in FIG. 6, between two frame image signals that are arranged in time series, three interpolation frame image signals are arranged (e.g, between the frame image signal Ap′ and the frame image signal Bp′, an interpolation image signal Ap′Bp′ [1], an interpolation image signal Ap′Bp′ [2], and an interpolation image signal Ap′Bp′ [3] are arranged).

Likewise, between two frame-type LED control signals that are arranged in time series, three interpolation frame- type LED control signals are arranged (e.g, between the frame-type LED control signal Ad′ and the frame-type LED control signal Bd′, an interpolation frame-type LED control signal Ad′Bd′ [1], an interpolation frame-type LED control signal Ad′Bd′ [2], and an interpolation frame- type LED control signal Ad′Bd′ [3] are arranged).

And, the interpolation frame image signal and the interpolation frame-type LED control signal which have the same timing correspond to each other (e.g, the interpolation frame image signal Ap′Bp′ [1] and the interpolation frame-type LED control signal Ad′Bd′ [1] correspond to each other; the interpolation frame image signal Ap′Bp′ [2] and the interpolation frame-type LED control signal Ad′Bd′ [2] correspond to each other; and the interpolation frame image signal Ap′Bp′ [3] and the interpolation frame-type LED control signal Ad′Bd′ [3] correspond to each other).

In other words, as described above, even if the frame frequency is speeded four times faster, between the image signal (the frame image signal and the interpolation frame image signal) displayed on the liquid crystal display panel 89 and the LED control signal (the frame-type LED control signal and the interpolation frame-type LED control signal) that controls the backlight from the backlight unit 79, a good corresponding relationship in harmonization is satisfied. As a result of this, the quality of the image displayed on the liquid crystal display panel 89 improves.

Here, as shown in FIG. 7, the contribution ratios (e.g., α1 to α3, β1 to β3 . . . are numbers equal to 1 or smaller) of one and the other of the two frame-type LED control signals may suitably change. This is because, if such contribution ratios are suitably changed, an interpolation frame-type LED control signal that is in better harmonization with the interpolation frame image signal is generated.

In the meantime, in the case of the backlight unit 79 of the active area type, a phenomenon, which is called a dynamic-image flicker that is caused by the resolution of the backlight unit 79 (the number of shined regions SA) lower than the resolution (the number of pixels) of the liquid crystal display panel 89, easily occurs. This dynamic-image flicker is a phenomenon in which in a case where the display image displayed on the liquid crystal display panel 89 overlaps with a plurality of shined regions SA, if the brightness of each shined region SA rapidly changed, the brightness change becomes conspicuous.

However, the backlight unit 79 which generates the interpolation frame-type LED control signal curbs the dynamic-image flicker. For example, as shown in FIG. 8, brightness levels that correspond to the frame-type LED control signals Ad′, Bd′, Cd′, Dd′, . . . are defined as La, Lb, Lc, and Ld . . . , and it is supposed that there is a relationship La>Lb>Lc>Ld . . . between these brightness levels La to Ld . . . .

And, it is supposed that a difference between La and Lb, a difference between Lb and Lc, and a difference between Lc and Ld are differences that cause the brightness flicker. In this case, for example, in a case of an LED control signal that causes a brightness change represented by a one-dot-one-bar line, the brightness flicker occurs.

However, in a case of an LED control signal (frame-type LED control signal, interpolation frame-type LED control signal) that causes a brightness change represented by a solid line, the brightness change is relatively moderate. This is because a brightness Lab which corresponds to the interpolation frame-type LED control signal Ad′Bd′ is lower than the brightness La but higher than the brightness Lb; a brightness Lbc which corresponds to the interpolation frame-type LED control signal Bd′Cd′ is lower than the brightness Lb but higher than the brightness Lc; and a brightness Lcd which corresponds to the interpolation frame-type LED control signal Cd′Dd′ is lower than the brightness Lc but higher than the brightness Ld.

And, as described above, if the brightness change becomes small (if the resolution of the brightness change becomes small), a border between different brightnesses becomes inconspicuous. Because of this, the backlight unit 79 that generates the interpolation frame-type LED control signal easily supplies the backlight which curbs the brightness change compared with the backlight unit 79 that is not able to generate the interpolation frame-type LED control signal. And, on the liquid crystal display panel 89 that receives the backlight from this backlight unit 79, the dynamic-image flicker becomes unlikely to occur.

In the meantime, of the reception portion 51, the image signal process portion 52, the liquid crystal display panel controller 31, and the micro unit 11 (the main micro 12 and the LED controller 13) that are shown in FIG. 1, part or all the members may be incorporated in the liquid crystal display panel 89 or in the backlight unit 79. In short, it is sufficient if these members are incorporated in the liquid crystal display device 99. However, in a case where the above-described brightness correction control is performed by the backlight unit 79 alone, at least the reception portion 51, the image signal process portion 52, and the micro unit 11 are incorporated in the backlight unit 79.

Besides, in a case where the LED controller 13 (in detail, the frame light adjustment unit 21) of the micro unit 11 generates the interpolation frame-type LED control signal, the light source color image signals (RSd, GSd, BSd) are used. This signal is a 60-Hz signal to which a special process is not applied, so that the control burden on the LED controller 13 is relatively small.

However, in a case where the signal, which is transmitted to the LED controller 13 and processed by the frame light adjustment unit 21, is a signal that undergoes a complicated process like, for example, the panel processed color image signal (RSp′, GSp′, BSp′) that is processed by the liquid crystal display panel controller 31, the control burden on the LED controller 13 is not immune from becoming heavy. Besides, the circuit structure becomes complicated.

However, as shown in FIG. 1, in the circuit structure incorporated in the backlight unit 79 (and the liquid crystal display device 99), the liquid crystal display panel controller 31 applies a process to the panel processed color image signal (RSp, GSp, BSp) that is a signal separated by the image signal process portion 52 while the LED controller 13 applies a process to the light source color image signal (RSd, GSd, BSd).

Because of this, the control burden on the LED controller 13 (and the micro unit 11) is relatively small. Besides, because the control burden is small, the cost of various circuits (e.g., ASIC: Application Specific Integrated Circuit) also decreases. Besides, the circuit structure itself is simplified.

### Other Embodiments

In the meantime, the present invention is not limited to the above embodiments and various modifications are possible without departing from the spirit of the present invention. For example, the following backlight unit 79 (and the liquid crystal display device 99) is also conceivable.

As shown in FIG. 9A, in the process for generating the interpolation frame image signal, various signals are generated in accordance with the contribution ratios (e.g., δ, ε . . . ) of one and the other of the two frame image signals that are arranged in time series. In this case, the interpolation frame image signal is likely to be generated in accordance with a 100% contribution ratio (maximum contribution ratio) of the one frame image signal.

For example, in a case where the interpolation frame image signal Ap′Bp′ is generated in accordance with a contribution ratio of δ=1 (maximum contribution ratio), as shown in FIG. 9B, the interpolation frame image signal Ap′Bp′ (see FIG. 9A) substantially becomes identical to the frame image signal Ap′ (the interpolation frame image signal Ap′Bp′=1×Ap′+(1−1)×Bp′=Ap′).

As described above, in the case where the interpolation frame image signal substantially disappears, the micro unit 11, as described below, generates the interpolation frame-type LED control signal. In other words, the micro unit 11 sets the contribution ratio of the frame-type LED control signal, which corresponds to the one frame image signal that has the 100% contribution ratio, at 100% (maximum contribution ratio) and generates the interpolation frame-type LED control signal.

For example, in the case where the interpolation frame image signal Ap′Bp′ is substantially identical to the frame image signal Ap′, the interpolation frame-type LED control signal Ad′Bd′, which is generated in accordance with the contribution ratios of the frame-type LED control signal Ad′ and the frame-type LED control signal Bd′, is generated in accordance with a 100% contribution ratio (α=1) of the frame-type LED control signal Ad′ that corresponds to the frame image signal Ap′. In this case, the interpolation frame-type LED control signal Ad′Bd′ (see FIG. 9B), as shown in FIG. 9C, becomes substantially identical to the frame-type LED control signal Ad′ (the interpolation frame-type LED control signal Ad′Bd′=1×Ad′+(1−1)×Bd′=Ad′).

In other words, in a case where the liquid crystal display panel controller 31 substantially does not generate the interpolation frame image signal but repeats the frame image signal, the micro unit 11 (in detail, the panel light adjustment unit 21 of the LED controller 13) also does not generate the interpolation frame-type LED control signal but repeats the frame-type LED control signal.

Because of this, for example, as shown in FIG. 9C, the frame image signals Ap′, A p′, B p′, B p′, Cp′, . . . and the frame-type LED control signals Ad′, Ad′, Bd′, Bd′, C 3′, . . . have the same timing as each other; and a good corresponding relationship in harmonization is satisfied. Accordingly, in the case where the frame image signal is displayed on the liquid crystal display panel 89, the display image becomes a relatively high-quality image.

In the meantime, in the above description, the backlight unit 79 of a direct type is described as an example. However, this is not limiting. For example, as shown in FIG. 10, a backlight unit 69 (tandem-type backlight unit), which incorporates a tandem-type light guide plate 77gr where wedge-shape light guide pieces 77 are laid all over, may be used.

Besides, in the above description, the reception portion 51 receives the image voice signal such as the television broadcast signal and the like and the image signal process portion 52 processes the image signal of the signal. Because of this, it is possible to say that a reception device that incorporates such liquid crystal display device 99 is a television broadcast reception device (so-called liquid crystal television). However, the image signal processed by the liquid crystal display device 99 is not limited to the television broadcast. For example, an image signal contained in a record medium in which content of a movie and the like is recorded may be used, or an image signal transmitted via the Internet may be used.

Besides, various correction processes, which include the brightness correction process by the micro unit 11, are achieved by a data generation program. And, this data generation program is a program that is executable on a computer and may be recorded in a record medium that is readable by the computer. This is because the program recorded in a record medium becomes mobile.

Here, as this record medium, for example, there are tape relatives such as a separable magnetic tape, a cassette tape and the like; disc relatives such as a magnetic disc, an optical disc like a CD-ROM and the like; card relatives such as an IC card (a memory card is included), an optical card and the like; and semiconductor memory relatives such as a flash memory and the like.

Besides, the micro unit 11 may obtain the data generation program over communication from a communication network. Here, as the communication network by cable or wireless, there are the Internet, infrared-rays communication network and the like.

### REFERENCE SIGNS LIST

11 micro unit (control unit)

12 main micro (part of the control unit)

13 LED controller (part of the control unit)

14 LED controller register group (part of the control unit)

15 LED driver control portion (part of the control unit)

21 frame light adjustment unit (part of the control unit)

22 LED frame memory (part of the control unit)

23 LED double-speed conversion portion (part of the control unit)

24 LED light adjustment portion (part of the control unit)

31 liquid crystal display panel controller

32 panel frame memory

33 motion detection portion

34 panel double-speed conversion portion

35 panel image adjustment portion

36 G/S control portion

51 reception portion

52 image signal process portion

55 LED driver

MJ LED module

62 LED (light source)

63 LED chip (light emitting chip)

65 thermistor (temperature measurement portion)

66 photo sensor

79 backlight unit (illumination device)

89 liquid crystal display panel (display panel)

99 liquid crystal display device (display device)

1. An illumination device that comprises:
a plurality of light sources that emit light in accordance with light amount adjustment data; and
a control unit that from image data which is a base of panel control data and light source control data, generates the light amount adjustment data by applying a process to the light source control data;
the control unit, based on the panel control data, generates the light amount adjustment data of a frame type to the number of 2 while making the light amount adjustment data correspond to two frame image data that are arranged in time series; and
from the two light amount adjustment data of the frame type, generates the light amount adjustment data of an interpolation frame type that corresponds to intermediate interpolation frame image data in a time passage between the two frame image data.

2. The illumination device according to claim 1, wherein the control unit changes contribution ratios of one and the other of the two light amount adjustment data of the fame type to generate the light amount adjustment data of the interpolation frame type.

3. The illumination device according to claim 2, wherein in a case where the interpolation frame image data is generated in accordance with one highest contribution ratio of the one and the other of the two frame image data that are arranged in time series, the control unit generates the light amount adjustment data of the interpolation frame type in accordance with the highest contribution ratio of the one of the light amount adjustment data that corresponds to the one of the frame image data.

4. The illumination device according to claim 1, wherein the control unit generates the light amount adjustment data of the frame interpolation type to the number of one or more.

5. A display device comprising:
the illumination device according to claim 1; and
a display panel that displays an image in accordance with image data.

6. The display device according to claim 5, further comprising:
an image signal process portion that separates the image data into panel control data and light source control data; and
a liquid display panel controller that applies a process to the panel control data to generate, as two frame image data, first frame image data and second frame image data that are arranged in time series; and generates interpolation frame image data from the first frame image data and the second frame image data;
the control unit applies a process to the light source control data to generate, as two light amount adjustment data of a frame type that are arranged in time series: first light amount adjustment data which corresponds to the first frame image data; and second light amount adjustment data which corresponds to the second frame image data; and
generates light amount adjustment data of an interpolation frame type from the first light amount adjustment data and the second light amount adjustment data.

7. A data generation method that from image data which is a base of panel control data and light source control data, generates light amount adjustment data by applying a process to the light source control data;
the data generation method generates, based on the panel control data, the light amount adjustment data of a frame type to the number of 2 while making the light amount adjustment data correspond to two frame image data that are arranged in time series; and
generates, from the two light amount adjustment data of the frame type, the light amount adjustment data of an interpolation frame type that corresponds to intermediate interpolation frame image data in a time passage between the two frame image data.

8. A data generation program that generates light amount control data on an illumination device that includes:
a plurality of light sources that emit light in accordance with the light amount adjustment data; and
a control unit that from image data which is a base of panel control data and light source control data, generates the light amount adjustment data by applying a process to the light source control data;
the data generation program, based on the panel control data, generates the light amount adjustment data of a frame type to the number of 2 while making the light amount adjustment data correspond to two frame image data that are arranged in time series; and
from the two light amount adjustment data of the frame type, generates the light amount adjustment data of an interpolation frame type that corresponds to intermediate interpolation frame image data in a time passage between the two frame image data;
wherein the data generation program is executed by the control unit.

9. A computer-readable record medium that records the data generation program according to claim 8.
